(19) United States
(12) Patent Application Publication
(10) Pub. No.: US 2022/0398609 A1
(43) Pub. Date: Dec. 15, 2022

(54) DYNAMIC LEAD OUTREACH ENGINE

(71) Applicant: Aktify, Inc., Lehi, UT (US)

(72) Inventors: Jason Feriante, Bluffdale, UT (US); Johny David Garcia, West Bountiful, UT (US); Jessie Warner, Lehi, UT (US); Joe Hawkins, Bluffdale, UT (US); Kreg Peeler, Draper, UT (US)

(21) Appl. No.: 17/347,207

(22) Filed: Jun. 14, 2021

(51) Int. Cl. G06Q 30/02; G06N 20/00; G06Q 10/06

(52) U.S. Cl. CPC G06Q 30/0202; G06N 20/00; G06Q 30/0201; G06Q 10/06311

(57) ABSTRACT

A dynamic lead outreach engine can dynamically determine a next consumer interaction for a lead. The dynamic lead outreach engine can include a next consumer interaction module that employs artificial intelligence techniques to predict a next consumer interaction based on lead metadata, an outreach template and past consumer interactions. In this way, the dynamic lead outreach engine can facilitate applying a variety of outreach approaches when initiating consumer interactions with leads.

### CROSS-REFERENCE TO RELATED APPLICATIONS

N/A

### BACKGROUND

A lead can be considered a contact, such as an individual or an organization, that has expressed interest in a product or service that a business offers. A lead could merely be contact information such as an email address or phone number, but may also include an individual's name, address or other personal/organization information, an identification of how an individual expressed interest (e.g., providing contact/personal information via a web-based form, signing up to receive periodic emails, calling a sales number, attending an event, etc.), communications the business may have had with the individual, etc. A business may generate leads itself (e.g., as it interacts with potential customers) or may obtain leads from other sources.

A business may use leads as part of a marketing or sales campaign to create new business. For example, sales representatives may use leads to contact individuals to see if the individuals are interested in purchasing any product or service that the business offers. These sales representatives may consider whatever information a lead includes to develop a strategy that may convince the individual to purchase the business's products or services. When such efforts are unproductive, a lead may be considered dead. Businesses typically accumulate a large number of dead leads over time.

Recently, efforts have been made to employ artificial intelligence to identify leads that are most likely to produce successful results. For example, some solutions may consider the information contained in leads to identify which leads exhibit characteristics of the ideal candidate for purchasing a business's products or services. In other words, such solutions would inform sales representatives which leads to prioritize, and then the sales representatives would use their own strategies to attempt to communicate with the respective individuals.

### BRIEF SUMMARY

The present invention extends to a dynamic lead outreach engine that can dynamically determine a next consumer interaction for a lead. The dynamic lead outreach engine can include a next consumer interaction module that employs artificial intelligence techniques to predict a next consumer interaction based on lead metadata, an outreach template and past consumer interactions. In this way, the dynamic lead outreach engine can facilitate applying a variety of outreach approaches when initiating consumer interactions with leads.

In some embodiments, the present invention may be implemented by a dynamic lead outreach engine as a method for dynamically determining a next consumer interaction. A dynamic lead outreach engine can obtain lead metadata for a first lead and may then select a first outreach template from among a plurality of outreach templates based on the lead metadata. The dynamic lead outreach engine can predict a next consumer interaction based on the lead metadata and the first outreach template. The dynamic lead outreach engine can then schedule the next consumer interaction.

In some embodiments, the present invention may be implemented as a lead management system that includes a dynamic lead outreach engine that is configured to: obtain lead metadata for a first lead; select a first outreach template from among a plurality of outreach templates based on the lead metadata; obtain past consumer interactions for the first lead; predict a next consumer interaction based on the lead metadata, the past consumer interactions and the first outreach template; and scheduling the next consumer interaction.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which one or more embodiments of the present invention may be implemented;

FIG. 2 provides an example of various components that a lead management system may include in accordance with one or more embodiments of the present invention;

FIG. 3 provides an example of how a dynamic lead outreach engine can interface with various components of a lead management system;

FIGS. 4A-4C provide an example of how a dynamic lead outreach engine can dynamically determine and schedule a next consumer interaction for a lead;

FIG. 5 provides an example of how the next consumer interaction can be initiated to generate additional consumer interactions; and

FIG. 6 provides an example of how the dynamic lead outreach engine can use the additional consumer interactions to dynamically determine and schedule an additional next consumer interaction.

### DETAILED DESCRIPTION

In the specification and the claims, the term “consumer” should be construed as an individual. A consumer may or may not be associated with an organization. The term “lead” should be construed as information about, or that is associated with, a particular consumer. In some contexts, the terms consumer and lead may be used interchangeably. The term “consumer computing device” can represent any computing device that a consumer may use and by which a lead management system may communicate with the consumer. In a typical example, a consumer computing device may be a consumer's phone.

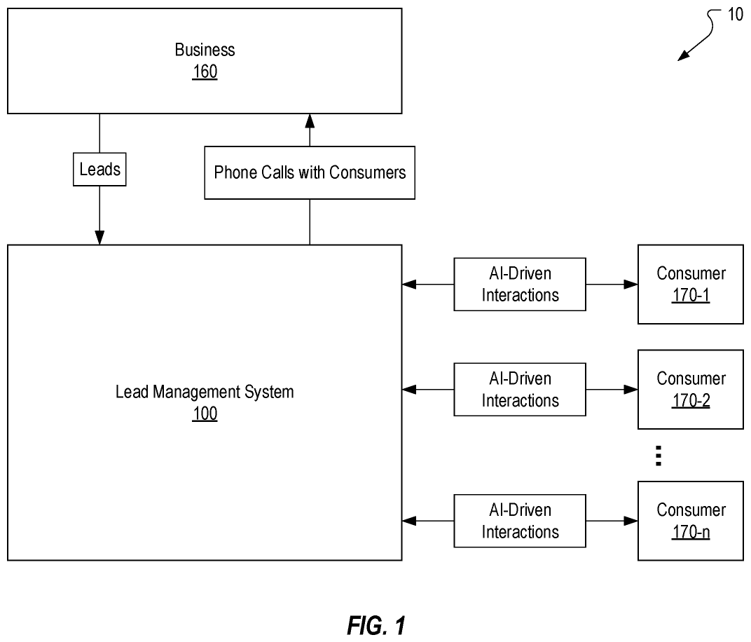

FIG. 1 provides an example of a computing environment 10 in which embodiments of the present invention may be implemented. Computing environment 10 may include a lead management system 100, a business 160 and consumers 170-1 through 170-n (or consumer(s) 170). As shown, business 160 can provide leads, in the form of raw lead data, to lead management system 100 where the leads can correspond with consumers 170. Typically, these leads may be dead leads that business 160 has accumulated, but any type of lead may be provided in embodiments of the present invention. Although only a single business 160 is shown, there may typically be many businesses 160.

Lead management system 100 can perform a variety of functionality on the leads to enable lead management system 100 to have AI-driven interactions with consumers 170. For example, these AI-driven interactions can be text messages that are intended to convince consumers 170 to have a phone call with a sales representative of business 160. Once the AI-driven interactions with a particular consumer 170 are successful (e.g., when the particular consumer 170 agrees to a phone call with business 160), lead management system 100 may initiate/connect a phone call between the particular consumer 170 and a sales representative of business 160. Accordingly, by only providing its leads, including its dead leads, to lead management system 100, business 160 can obtain phone calls with consumers 170.

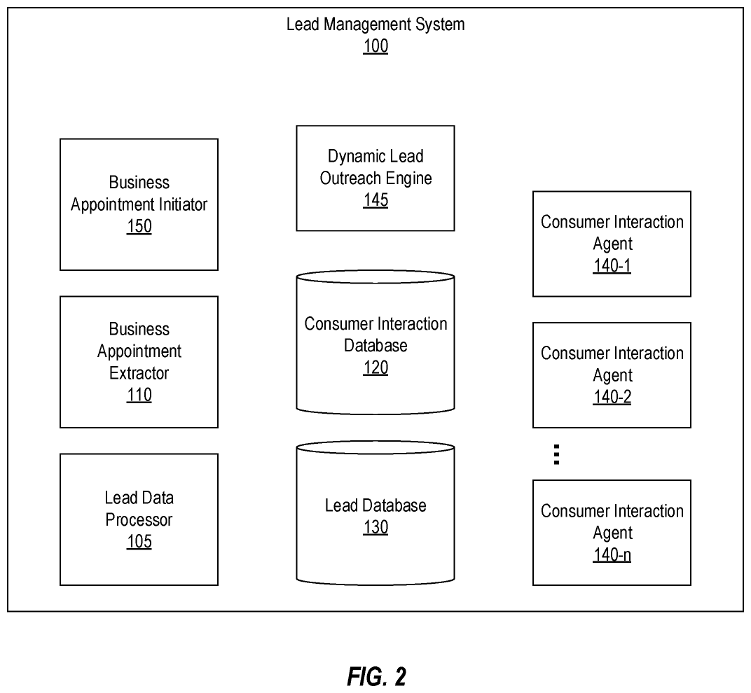

FIG. 2 provides an example of various components that lead management system 100 may include in one or more embodiments of the present invention. These components may include a lead data processor 105, a business appointment extractor 110, a consumer interaction database 120, a lead database 130, consumer interaction agents 140-1 through 140-n (or consumer interaction agent(s) 140), a dynamic lead outreach engine 145 and a business appointment initiator 150.

Lead data processor 105 can represent one or more components of lead management system 100 that process the leads received from business 160 (e.g., the raw lead data received from business 160) to generate lead processing result objects. These lead processing result objects may be stored in lead database 130. As described in U.S. patent application Ser. No. 17/346,055, which is incorporated by reference, these lead processing result objects are configured to facilitate and maximize the efficiency and accuracy of AI-driven interactions that lead management system 100 may have with the corresponding consumers.

Business appointment extractor 110 can represent one or more components of lead management system 100 that implement a scheduling language and model for extracting appointments from consumer interactions. Consumer interaction database 120 can represent one or more data storage mechanisms for storing consumer interactions or data structures defining consumer interactions.

Consumer interaction agents 140 can be configured to interact with consumers 170 via consumer computing devices. For example, consumer interaction agents 140 can communicate with consumers 170 via text messages, emails or another text-based mechanism. These interactions, such as text messages, can be stored in consumer interaction database 120 and associated with the respective consumer 170 (e.g., via associations with the corresponding lead defined in lead database 130). Consumer interaction agents 140 can employ the lead processing result objects to dynamically determine the timing and content of these interactions.

Dynamic lead outreach engine 145 can represent one or more components of lead management system 100 that are configured to dynamically determine the content, timing and/or other characteristic of consumer interactions that consumer interaction agents 140 send to consumers 170. This dynamic determination can be based on a number of factors such as lead preferences, lead status, campaign context, past consumer interactions, etc.

Business appointment initiator 150 can represent one or more components of lead management system 100 that are configured to initiate an appointment (e.g., a phone call or similar communication) between a consumer 170 and a representative of business 160. For example, business appointment initiator 150 could establish a call with a consumer and then connect the business representative to the call. In some embodiments, business appointment extractor 110 can intelligently select the timing of such appointments by applying a scheduling language and model to the consumer interactions that consumer interaction agents 140 have with consumers 170 as is described in U.S. patent application Ser. No. 17/346,032, which is incorporated by reference.

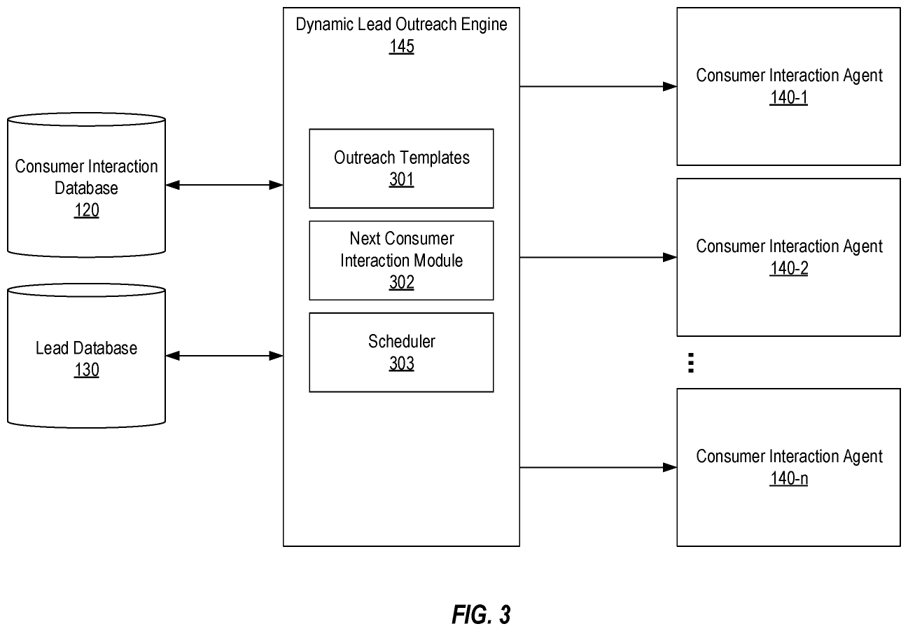

FIG. 3 provides an overview of how dynamic lead outreach engine 145 may be used in one or more embodiments of the present invention. As shown, dynamic lead outreach engine 145 can be interfaced with consumer interaction agents 140 for the purpose of providing guidance on the nature and timing of consumer interactions that consumer interaction agents 140 should have. To provide this guidance, dynamic lead outreach engine 145 may access lead database 130 to obtain lead preferences, lead status, campaign context or other contextual information (hereinafter “lead metadata”) for a lead and use the lead metadata to determine one or more of outreach templates 301 to use in determining the next consumer interaction for the lead. A next consumer interaction module 302 can implement artificial intelligent techniques to dynamically determine the next consumer interaction based on the lead metadata and the selected outreach template. If past consumer interactions exist for the lead, next consumer interaction module 302 may dynamically determine the next consumer interaction based also on the past consumer interactions. After determining the next consumer interaction, dynamic lead outreach engine 145 can employ a scheduler 303 to schedule when consumer interaction agents 140 should generate the next consumer interaction (e.g., when a consumer interaction agent 140 should send a text to the respective consumer). Scheduler 303 may also monitor these next consumer interactions that consumer interaction agents 140 have to reschedule any next consumer interaction that may fail (e.g., when the consumer does not respond to a text).

By employing outreach templates 301 in conjunction with next consumer interaction module 302, dynamic lead outreach engine 145 can seamlessly cause consumer interaction agents 140 to employ different approaches when initiating and continuing consumer interactions where any given approach may be dynamically selected to approximate the approach a skilled human may take. Dynamic lead outreach engine 145 may therefore be particularly useful in reviving dead leads.

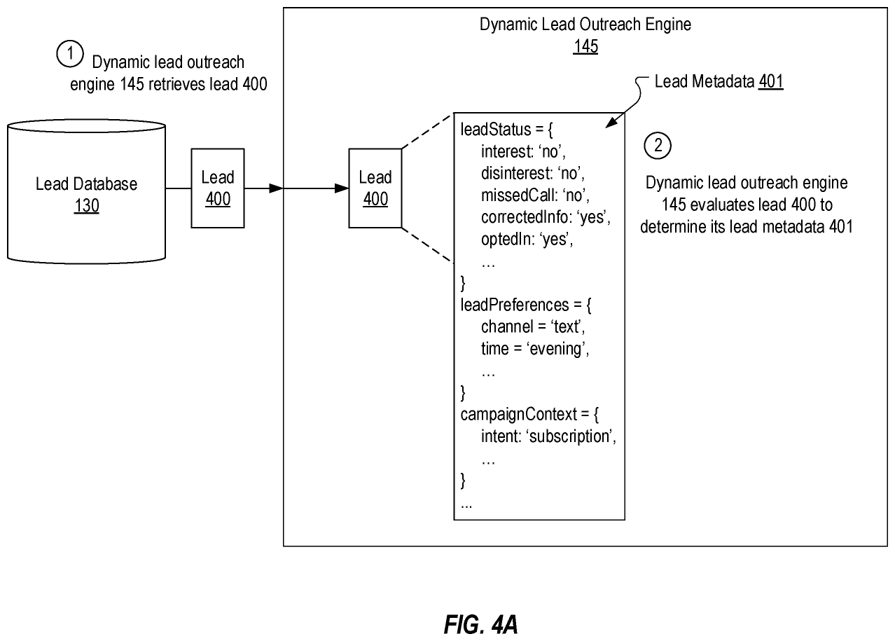

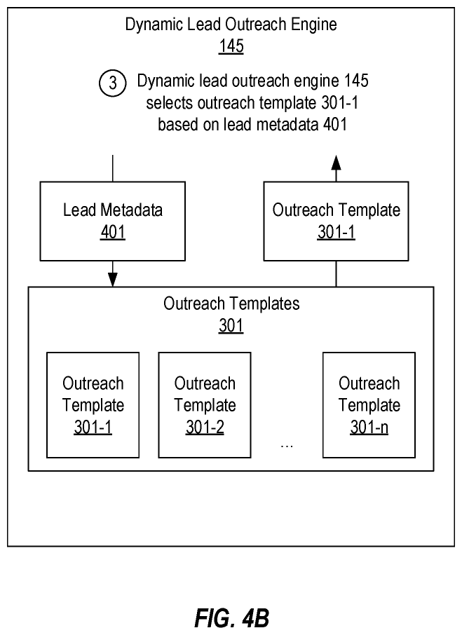

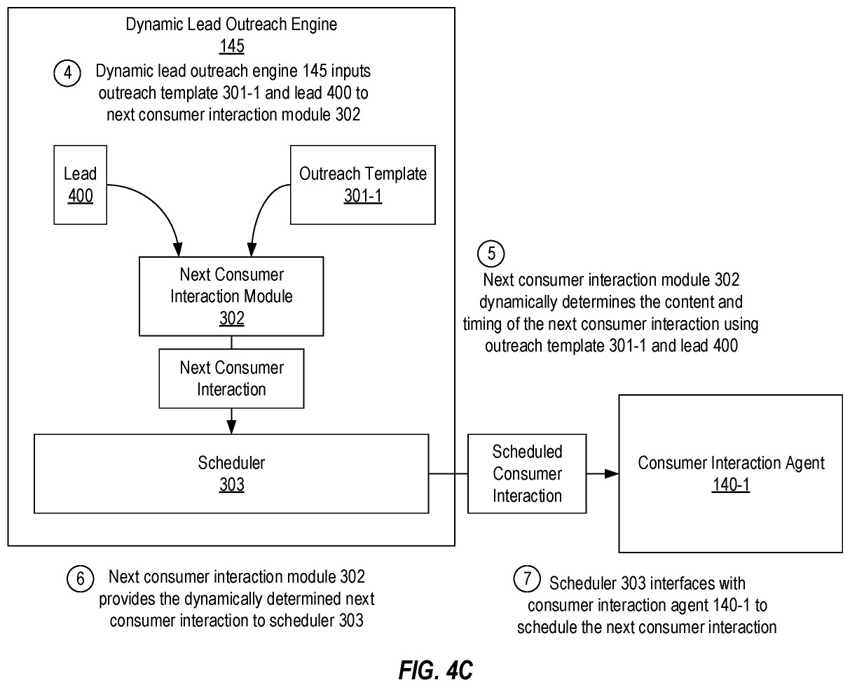

FIGS. 4A-4C provide an example of how dynamic lead outreach engine 145 dynamically determine and schedule the next consumer interaction for a lead 400. Turning to FIG. 4A, in step 1, dynamic lead outreach engine 145 can obtain lead 400 from lead database 130. Lead 400 may define a variety of information such as a name of the consumer, contact information, address/location information and, of primarily relevance to embodiments of the present invention, lead metadata 401. Lead metadata 401 may include lead status (e.g., whether the lead has expressed interest or disinterest, whether the lead has missed a call that lead management system 100 attempted, whether the lead has provided corrected information, whether the lead as opted in to consumer interactions, etc.), lead preferences (e.g., a preferred channel for consumer interactions, a preferred time for receiving consumer interactions, etc.), a campaign context (e.g., the intent of the campaign that a business 160 has requested in providing lead 400 such as to get the lead/consumer to subscribe to a service, purchase a good, provide a review or evaluation, etc.). In step 2, dynamic lead outreach engine 145 can evaluate lead 400 to determine its lead metadata 401.

Turning to FIG. 4B, in step 3, dynamic lead outreach engine 145 can select one of outreach templates 301 based on lead metadata 401, which in the depicted example is outreach template 301-1. Outreach templates 301 can define values for parameters that next consumer interaction module 302 employs as part of determining what the next consumer interaction should be for a particular lead. A particular outreach template 301 may define a set of values for such parameters that will influence the AI-based determination that next consumer interaction module 302 makes. For example, in some embodiments, such values may be in the form of weights that are applied to parameters of a machine learning algorithm that next consumer interaction module 302 employs. These parameters could include parameters for predicting a best time, best channel, best content, etc. for the next consumer interaction. Accordingly, dynamic lead outreach engine 145 can employ lead 400's lead status, lead preferences, campaign context or other lead metadata to select outreach template 301-1 which can define values for influencing next consumer interaction module 302 to predict/determine the next consumer interaction for lead 400 in accordance with a particular outreach approach that outreach template 301-1 represents.

A wide variety of outreach templates 301 can be defined to represent any suitable outreach approach. For example, administrators of lead management system 100 can define outreach templates 301 to represent an outreach approach to be used when a lead has expressed interest, an outreach approach to be used when a lead has expressed disinterest, an outreach approach to be used when a lead has missed a call, an outreach approach to use when the lead has corrected his or her information, an outreach approach to use when the lead has opted in to receive consumer interactions or any other outreach approach that may be suitable for any combination of values of lead metadata 401.

Turning to FIG. 4C, in step 4, dynamic lead outreach engine 145 can input lead 400 and outreach template 301-1 to next consumer interaction module 302. In this example, it is assumed that lead management system 100 has not yet had consumer interactions with lead 400 and therefore no past consumer interactions are provided to next consumer interaction module 302 at this point. In step 5, next consumer interaction module 302 dynamically determines the content, timing and/or other aspect of the next consumer interaction for lead 400 using outreach template 301-1 and lead 400, including lead metadata 401. For example, next consumer interaction module 302 could input lead metadata 401 and outreach template 301-1 to a machine learning model that predicts the best content, timing and/or other aspect of the next consumer interaction. By using outreach template 301-1 as an input, this prediction of the best content, timing and/or other aspect of the next consumer interaction can conform to the outreach approach that outreach template 301-1 represents.

In step 6, next consumer interaction module 302 can provide the next consumer interaction predicted for lead 400 to scheduler 303. Then, in step 7, scheduler 303 can interface with the appropriate consumer interaction agent 140, such as consumer interaction agent 140-1, to schedule the next consumer interaction. For example, scheduler 303 could specify the content and the timing for the next consumer interaction.

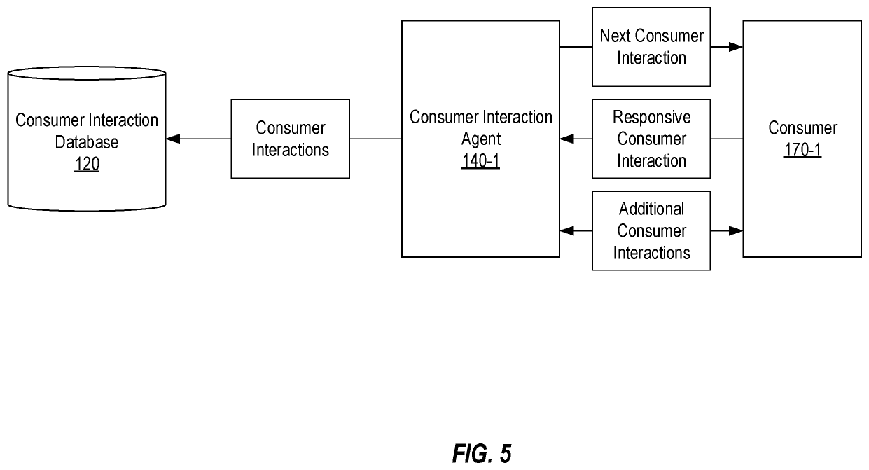

As represented in FIG. 5, as a result of the above-described process, consumer interaction agent 140-1 will initiate the next consumer interaction with the respective consumer (which is assumed to be consumer 170-1) at the predicted best time and using the predicted best content for the outreach approach that outreach template 301-1 represents. As consumer 170-1 responds and as consumer interaction agent 140-1 and consumer 170-1 have additional consumer interactions, consumer interaction agent 140-1 may store the consumer interactions in consumer interaction database 120.

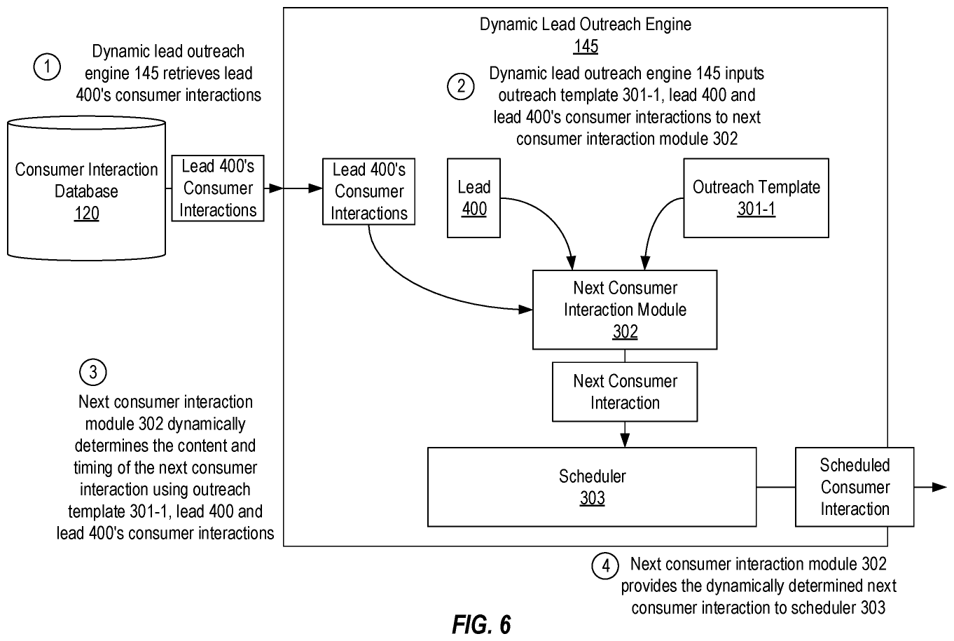

Once past consumer interactions are stored for lead 400, dynamic lead outreach engine 145 may use the past consumer interactions when determining the next consumer interaction with lead 400. FIG. 6 provides such an example and could represent a subsequent attempt that lead management system 100 makes to interact with lead 400. This attempt could be made at any time relative to the next consumer interaction that occurs in FIG. 4C including immediately thereafter or days, weeks or months later.

In FIG. 6, it is presumed that dynamic outreach engine 145 has already obtained lead 400 and determined that outreach template 301-1 should again be used. However, in some embodiments, dynamic outreach engine 145 may select a different outreach template 301 to use based on current lead metadata 401. In any case, in step 1, dynamic lead outreach engine 145 retrieves lead 400's consumer interactions from consumer interaction database 120. In step 2, dynamic lead outreach engine 145 can input lead 400, lead 400's consumer interactions and outreach template 301-1 to next consumer interaction module 302. In step 3, next consumer interaction module 302 dynamically determines the content, timing and/or other aspect of the next consumer interaction for lead 400 using outreach template 301-1, lead 400, including lead metadata 401, and lead 400's consumer interactions. For example, next consumer interaction module 302 could input outreach template 301-1, lead metadata 401 and lead 400's consumer interactions to a machine learning model that predicts the best content, timing and/or other aspect of the next consumer interaction. Then, in step 4, next consumer interaction module 302 can provide the dynamically determined next consumer interaction for lead 400 to scheduler 303. Scheduler 303 can then interface with the appropriate consumer interaction agent 140 as described above. This process can be repeated to continue predicting the content, timing and/or other aspect of future next consumer interactions for lead 400 to ensure that such consumer interactions are in accordance with the outreach approach that outreach template 301-1 represents.

In summary, dynamic lead outreach engine 145 can enable and maximize the efficiency and effectiveness of dynamically determining next consumer interactions for leads. Dynamic lead outreach engine 145 can implement AI-based techniques to perform these dynamic determinations using any available lead metadata and available consumer interactions. As a result, a wide variety of outreach approaches can be implemented to maximize the likelihood that consumers 170 will agree to communicate with businesses 160.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for dynamically determining a next consumer interaction, the method comprising:
obtaining lead metadata for a first lead;
selecting a first outreach template from among a plurality of outreach templates based on the lead metadata;
predicting a next consumer interaction based on the lead metadata and the first outreach template; and
scheduling the next consumer interaction.

2. The method of claim 1, wherein the lead metadata includes a lead status.

3. The method of claim 1, wherein the lead metadata includes lead preferences.

4. The method of claim 1, wherein the lead metadata includes a campaign context.

5. The method of claim 1, wherein the next consumer interaction is predicted using a machine learning model.

6. The method of claim 5, wherein the first outreach template defines one or more values for parameters used by the machine learning model.

7. The method of claim 1, wherein predicting the next consumer interaction comprises predicting content of the next consumer interaction.

8. The method of claim 1, wherein predicting the next consumer interaction comprises predicting timing of the next consumer interaction.

9. The method of claim 8, wherein scheduling the next consumer interaction comprises specifying the predicted timing of the next consumer interaction to a consumer interaction agent.

10. The method of claim 1, wherein the next consumer interaction is predicted based also on one or more past consumer interactions for the first lead.

11. The method of claim 1, further comprising:
determining that the lead metadata has been updated;
selecting a second outreach template based on the updated lead metadata;
predicting a second next consumer interaction based on the updated lead metadata and the second outreach template; and
scheduling the second next consumer interaction.

12. One or more computer storage media storing computer executable instructions which when executed implement a method for dynamically determining a next consumer interaction, the method comprising:
obtaining lead metadata for a first lead;
selecting a first outreach template from among a plurality of outreach templates based on the lead metadata;
predicting a next consumer interaction based on the lead metadata and the first outreach template; and
scheduling the next consumer interaction.

13. The computer storage media of claim 12, wherein the lead metadata includes a lead status.

14. The computer storage media of claim 12, wherein the lead metadata includes lead preferences.

15. The computer storage media of claim 12, wherein the lead metadata includes a campaign context.

16. The computer storage media of claim 12, wherein the next consumer interaction is predicted using a machine learning model.

17. The computer storage media of claim 16, wherein the first outreach template defines one or more values for parameters used by the machine learning model.

18. The computer storage media of claim 12, wherein predicting the next consumer interaction comprises predicting content of the next consumer interaction.

19. The computer storage media of claim 1, wherein predicting the next consumer interaction comprises predicting timing of the next consumer interaction.

20. A lead management system comprising:
one or more processors; and
computer storage media storing a dynamic lead outreach engine that is configured to:
obtain lead metadata for a first lead;
select a first outreach template from among a plurality of outreach templates based on the lead metadata;
obtain past consumer interactions for the first lead;
predict a next consumer interaction based on the lead metadata, the past consumer interactions and the first outreach template; and
scheduling the next consumer interaction.
